(19) United States
(12) Patent Application Publication
(10) Pub. No.: US 2007/0190256 A1
(43) Pub. Date: Aug. 16, 2007

(54) Method and assembly for colorizing a substrate material and product created thereby

(76) Inventors: Richard J. Darby, Danville, IL (US); Eugene L. Freiburger, Lisbon, IA (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/353,344

(22) Filed: Feb. 14, 2006

(51) Int. Cl. B05D 7/00; B05C 1/00

(52) U.S. Cl. 427/407.1; 118/200

(57) ABSTRACT

A method and assembly for surface applying a color scheme to an article surface and including securing the article upon a worktable associated with a numerically controllable colorant applicator, such that a textured surface associated with the article is exposed to the colorant applicator. Additional steps include applying the colorant, in one or more successive coatings, upon the textured surface, following drying of which a sealant is applied over the colored and textured surface. Also included is a colorized article produced according to the above method and assembly, in addition to an associated computer writeable medium for executing numerically controlled application of a desired colorant scheme.

### BACKGROUND OF THE INVENTION

1. Field of the Invention

The present invention discloses a novel method for applying a digital colorization scheme to an article. The method, assembly and associated article created thereby allows for the colorization of materials not previously suitable for receiving a digitally applied ink or dye, in both a smudge and UV fade-resistant fashion and to both planar shaped as well as three-dimensional shaped relief articles.

2. Description of the Prior Art

The prior art is well documented with various examples of ink jet imprinting apparatuses and processes. Of particular note are references directed to assemblies capable of applying inks to such non-traditional surfaces as ceramics and metals.

A first example of the prior art is set forth in Newton, U.S. Pat. No. 6,504,559, disclosing a method for applying an image onto a substrate using a digital thermal transfer printing process, particularly suitable for applying a ceramic ink to a substrate then fired to completion. The substrate materials are disclosed as including rigid sheets of material such as flat glass, ceramic sheets/tile, as well as three-dimensional objects constructed of ceramic, porcelain, porcelain enameled steel, and aluminum.

Process steps include transferring and/or storing the image digitally; transferring the stored image to a digital thermal transfer printer and then applying the image to the desired substrate such that the ink fuses to the substrate. Additional intermediate steps include applying the image to a transfer member from which the image is transferred to the substrate. Such transfer members include image receiving pads, belts or decals. The digital thermal transfer printer may also be configured to replace existing printing devices.

Sherman, U.S. Pat. No. 5,994,264, teaches providing a sheet of metal having a substantially clean surface, coating the clean surface with a thermosetting coating material containing a pigment, curing the material to provide a first coat layer, transfer printing the coated metal to provide a transfer printed layer, coating the transfer printed layer with a protective clear thermosetting coating material, and curing the protective clear coating material to provide a clear protective overcoat layer covering at least a portion of the transfer printed layer. The articles thus created are disclosed as being useful in the production of a variety of products, such as control panels, one-piece three-dimensional pictures and frames, and signs.

U.S. Pat. No. 6,420,309, issued to Grime, teaches a coated metal article, including a metal substrate, an adhesive primer on a surface of the metal substrate, a printed dye image bearing layer coated over the adhesive primer, the image bearing layer including a cured polymer thermoset resin having a printed dye image applied thereto. Finally, a layer of a thermally cured adhesive is applied between the cured polymer thermoset resin and the printed dye image.

Baker, U.S. Patent Application Publication No. 2004/0032477, teaches an apparatus for digitally generating an image including a printer for generating a desired image either onto a final substrate or an intermediate carrier sheet. The image is “built up” on the carrier sheet or substrate to form a sign, thereby eliminating the need for a weeding process. A layer of adhesive may be applied over the substrate, with an image built atop the adhesive. A consumable sheet is then brought in contact with the substrate to remove excess adhesive disposed upon the substrate, such that once the consumable sheet is separated from the substrate, the image remains on the substrate with the adhesive disposed therebetween.

Finally, U.S. Pat. No. 6,950,713, issued to Walthall, teaches a method for creating a three-dimensional engraving in a solid and a product created by such method. Specifically, a three-dimensional illustration of the solid is scanned into a numerical controller associated with a machining center. The 3D illustration is projected in the solid according to individual depths of cut. The solid is machined according to its projected depths. Shading is accomplished according to depth of cut and by immersing the solid into an oxide bath and successively abrasively removing a darkened coating according to depth of cut. Powder coating with a thermoset plastic, baking and curing steps provide a transparent coating to the solid.

### SUMMARY OF THE PRESENT INVENTION

The present invention discloses a novel method, assembly, article and associated computer writeable medium for applying a digital colorization scheme to an article. The present invention allows for the colorization of materials, such as in particular metals or other non-traditional solids not previously suitable for receiving a digitally applied ink or dye, and in both a smudge and UV fade-resistant fashion.

The method includes the initial step of texturing (or roughening) a surface of the article, selected from any of a variety of materials such as a solid material, either planar shaped or otherwise configured, and selected from (without limitation) such as steel, bronze, aluminum, wood, polymer, silver, nickel, stainless steel, titanium. Surface roughening can be provided by a number of different processes, but in one preferred application is accomplished by sandblasting the article surface to be subsequently painted, and through the use of glass beads. Appropriate texturing/roughening of the article surface is important to allow for proper and subsequent adhesion of the colorant applied ink/dye.

Once the article surface is prepped, it is mounted upon a worktable associated with a numerically controlled ink/dye applying assembly. In one variant, recessed surfaces are provided on a reverse facing surface of the article, provided by such as a bronze memorial plaque, and in order to properly center/locate the article before vacuum securing upon the platform surface.

A numerically operated and ink applying head is operatively communicated with the exposed article surface and in order to paint an appropriate colorized representation upon the article surface. In a preferred application, the worktable is traversable along XY coordinate axis, beneath a fixedly positioned ink or print head, it also being understood that the article workpiece can be fixedly supported and the colorant applicating head traversable.

It is further envisioned that, additional to colorizing substantially two-dimensional planar shaped articles, the colorization assembly, method of producing, and computer writeable medium is capable of being applied to a three-dimensional shaped articles, reliefs and the like, in instances such articles exhibiting a depth of several inches. The digital ink/print applicating heads are envisioned to include, additional to X, Y, Z coordinate traversable motion, the ability to rotate or arcuately traverse cooperatively in any of the three dimensions. Further, the inking devices employed may include technology allowing ink to be applied utilizing a robotic arm to obtain inking saturation in the X, Y, and Z coordinate scheme, and such as which may mimic the movement of an articulating (human) arm.

It is further contemplated that the colorant application is accomplished in a continuous linear fashion, such as through the application of a first white background (discounting the underlying colorization of the article) followed by a multicolored surface coat, the individual colors again capable of being seamlessly and interchangeably applied by the ink applying head during continuous relative movement of the article.

Upon completion of the fluid colorant application (this again including inks, dyes and the like), the applicant is allowed to dry (this step capable of being speeded up through the application of a brief baking process). Following this, selected portions of the painted surface may be polished, such as text portions and/or borders, after which a clear and UV-resistant coat of a suitable thermoset, e.g. acrylic, material is applied, such as by spraying, brushing, rolling or powder coating. Application of the clear coat prevents smudging, fading of the ink/dye, or contamination by environmental contaminants such as water, dirt and the like.

A numerically controllable and colorant applying assembly for colorizing the article surface is also disclosed and according to the process described above. An associated software program cooperatively employed with the assembly numerical processor includes subroutines for projecting an XY grid representation of the colorized scheme to be applied to the article surface, and applying the colorant scheme, such as again in a two coat and continuous linear feed fashion.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a plan view of an article exhibiting a colorized surface according to a preferred embodiment of the present invention;

FIG. 2 is an inverted view illustrating a number of recess holes for assisting in vacuum mounting the article within a numerically controlled ink or dye applying assembly;

FIG. 3 is a side view illustrating a numerically controlled process for painting a surface of the article;

FIG. 3A is an illustration similar to that shown in FIG. 3 and describing a three-dimensional and software guided inking process associated with a likewise 3D shaped workpiece article (or relief shape);

FIG. 4 is an illustration of a succeeding drying step following the ink/dye applying step;

FIG. 5 is an illustration of a fade/UV-resistant clear coat, such as acrylic, material upon the painted article surface; and

FIG. 6 is a flow schematic of the numerically controlled colorization process according to the present invention.

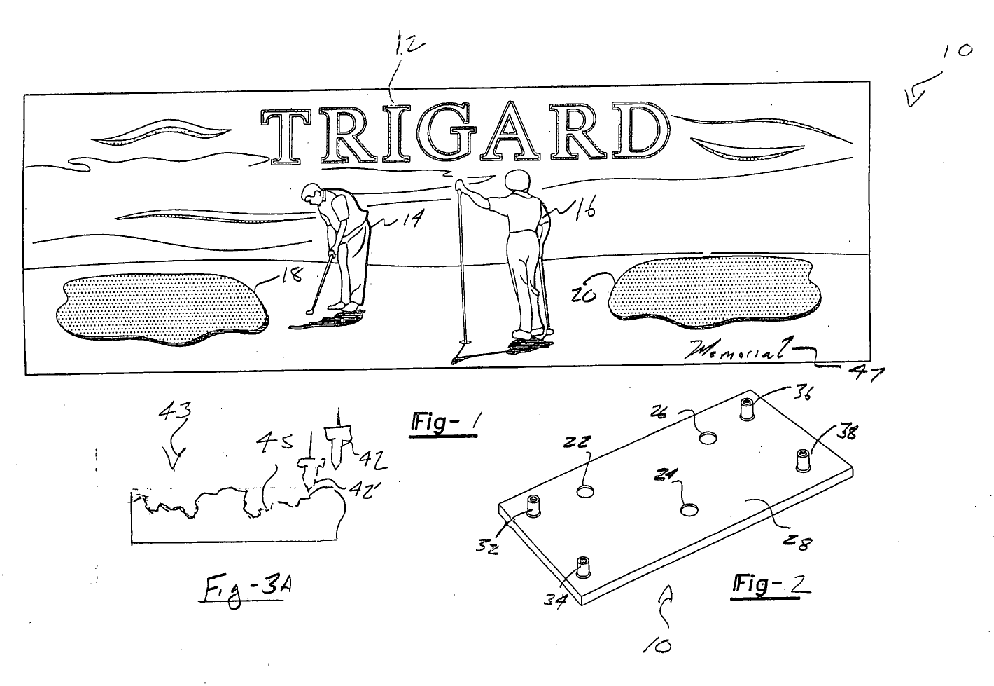

### DETAILED DESCRIPTION OF THE PREFERRED EMBODIMENTS

Referring now to FIG. 1, a memorial plaque is illustrated generally at 10 and which is produced according to the colorant applicating method, assembly and computer writeable medium according to the present invention. As previously explained, the present invention discloses a process for creating a multicolor representation upon a wide variety of typically non-traditional materials for inking, these including such as metallic based (as well as cellulose and polymer based) memorial plaques, reliefs, signage and the like.

As discussed above, the present invention further employs a unique software based and numerically driven code for reading and projecting a two-dimensional image upon a prepared surface of a solid (such as again a plaque by example), and prior to painting of the surface. Additionally, the present invention teaches a novel and numerically operated assembly for locating and painting the surface of the solid, this often resulting in a three-dimensional appearing representation created upon the solid.

Referring again to FIG. 1, the three-dimensional solid is illustrated, in one non-limiting example, in the form of a planar shaped plaque or marker, again at 10. The plaque, in one desired application, is provided as a sheet of bronze alloy material, such as further exhibiting a desired width, length and thickness (¼″ for example).

As is further understood the invention contemplates the utilization of any ferrous or non-ferrous material, or even any other suitable non-metallic material, as a three-dimensional solid, including again such as steel, bronze, aluminum, wood, polymer, silver, nickel, stainless steel, titanium. The colorant applying (painting) process will be described in additional detail, and includes the creation of both textual 12 and graphic 14, 16, 18 and 20 portions in three-dimensional fashion and within a selected face (or potentially multiple faces) of the solid 10.

The method includes the initial step of texturing (or roughening) a surface of the article, selected from any of the previously described variety of materials including solids either planar shaped or otherwise configured. Surface roughening is accomplished by any of a number of different processes, one preferred application consisting of sandblasting the article surface to be subsequently painted, such as through the use of glass beads (not shown).

As previously discussed, appropriate texturing/roughening of the article surface is important to allow for proper and subsequent adhesion of the colorant applied ink/dye. With this in mind, different texturing or roughing applications are contemplated dependent upon the material selected, it being understood that different surface treatment options are dictated for metallic based articles, than perhaps for wood or polymer based article solids.

It is also envisioned that an article surface can be provided “pretreated”, and in satisfaction of the requirements of the invention. This contemplates any previously accomplished application step or procedure for preparing the article surface, further such as resulting from the inherent material content of the article without any active surface prepping.

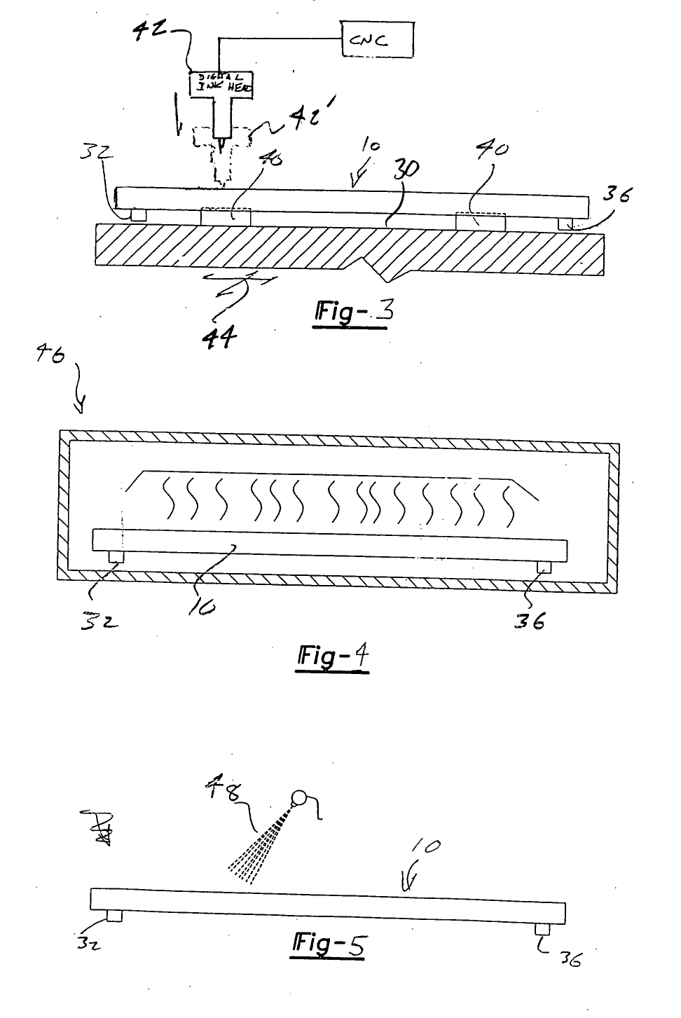

In a preferred application, and referring to the inverted illustration of the solid 10 in FIG. 4, recessed locating holes, such as the three represented at 22, 24 and 26, are formed on a reverse (non-painted) surface 28 of the bronze marker and such that these mate with positioned nubs (not shown) located on a platen or worktable associated with a numerical guided assembly (see further at 30 in FIG. 3). Additionally, and although not clearly shown, it is understood that a vacuum gasket seal or the like is employed to fixedly locate the solid 10 upon the worktable.

Additional to the recess holes 22, 24 and 26, any number of interiorly threaded and bolt attachment collars, such as typically the four represented at 32, 34, 36 and 38, can be also secured, such as by welding, to the plaque. In a preferred application, a capacitor discharge arc welding process is employed and by which a projecting tip associated with a downwardly facing end of each stud is placed in contact with a location of the solid surface. At this point, an ignited arc is created and by which a relatively thin fusion zone is generated between the stud (or bolt attachment collar) and the workpiece. The collar is then lunged into the welding pool thus created and, upon solidification of the material, accomplishes welding of each of the collars 32-38. The attachment of the collars typically occurs prior to the colorant/sealant stages, and so that, upon completion, the plaque 10 (or other suitable solid) can be attached to a marble fascia substratum or other suitable support surface.

Once the article surface is prepped, and referring again to FIG. 3, it is mounted upon a worktable associated with a numerically controlled ink/dye applying assembly. As previously described, the recessed surfaces provided on the reverse facing surface of the article facilitate proper centering/location of the article, such as prior to vacuum securing upon the work table surface 30. Additional support blocks, see at 40, can be provided additionally or alternatively for locating and securing the article 10 upon the worktable surface.

A numerically operated and ink applying head, illustrated at 42 in an upwardly retracted position, is communicated by a CNC controller representatively illustrated and is operatively communicated with the exposed article surface (see also downwardly extended phantom illustration 42′) in order to paint a desired colorized representation upon the article surface. The present invention contemplates the use of a variety of colorized ink and dye applying print heads, these further capable of applying any variety of colors in a digitally controlled and continuous/seamless manner.

In a preferred application, the worktable is traversable along XY coordinate axis, see as represented at 44, beneath the fixed ink or print head 42. It is also understood that the article workpiece can be fixedly supported and the colorant applicating head traversable as contemplated within the scope of the invention.

In a preferred embodiment, the colorant application process is accomplished during continuous linear feed or travel of the ink applying head relative to the surface of the article 10. In one variant, this is accomplished through the application of a first white background (the effect of doing this discounting the underlying colorization of the article surface), following which a multicolored surface coat is applied. As previously described, the individual colors are again capable of being seamlessly and interchangeably applied by the ink applying head during continuous and iterative passes of the article relative to the ink head.

Referring to FIG. 3A, the present assembly, method, computer writable medium and article also contemplates, as shown at 43, the colorizing of a 3D relief surface. It is envisioned that the relief articles can extend to depths of upwards of several inches (see as referenced by dimensional profile 45), the ability to ink or paint over being provided by a suitable ink or print head which is traversable in each of the X, Y and Z coordinates either successively or cooperatively, this further permitting the ink heads to draw arcuate and multicolored patterns in both two and three-dimensional fashion.

In order to accomplish this, the associated numerically controlling software program would include a scanned image, in 3D, mating with the actual profile of the workpiece/relief to be painted. The associated print/ink applying head would then be traversed in the manner above described and in order to “paint” or coat the surface of the article in one or multiple coats.

As described herein, it is contemplated that an initial white coat could be applied (this neutralizing the background coloration of the article itself), following which a succeeding colorizing coat can be applied. It is also envisioned that the initial (white) coat can be applied, in particular to 3D shaped surfaces, by immersing or otherwise coating the surface of the article within a suitable colorant and in order to save additional time during the colorizing process.

It is further envisioned that the inking device will incorporate technologies for print heads which allow for the application of ink utilizing a robotic arm to obtain inking saturation in the X, Y and Z coordinate scheme, utilizing movements mimicking that of a human (articulating) arm.

Upon completion of the fluid colorant application (this again including inks, dyes and the like), the applicant is allowed to dry. The drying step is capable of being speeded up through the application of a brief baking process and as is generally represented at 46 in FIG. 4. Following drying of the inked surface, selected portions are polished, such as text portions and/or borders. Other portions of the article surface can be etched or otherwise engraved, see as representatively shown at 47 in FIG. 1, this being in addition to the colorization process and occurring either prior or subsequent to colorization.

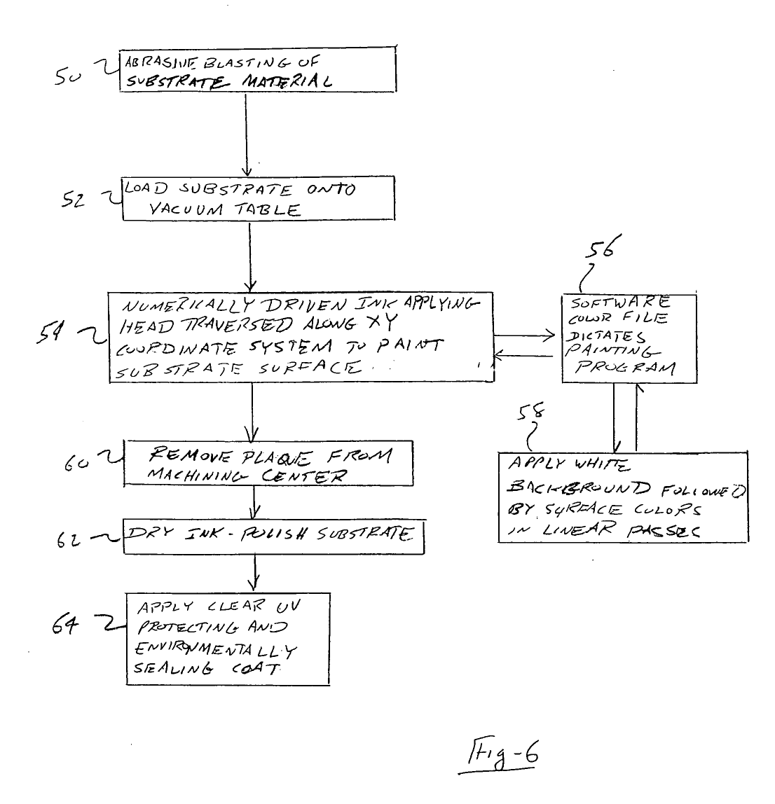

Referring now to FIG. 5, a clear and UV-resistant coat of a suitable thermoset, including but not limited to an acrylic material incorporating an ultraviolet inhibitor, is applied such as by spraying, brushing, rolling or powder coating, and which is represented generically by applicator 48. Application of the clear coat prevents smudging, fading of the ink/dye and associated article surface, as well as contamination by environmental contaminants such as water, dirt and the like.

Referring finally to FIG. 6, a flow schematic of the numerically controlled colorization process is illustrated according to the present invention and includes an initial step 50 by which the article surface undergoes abrasive blasting (texturing). At step 52, the article substrate is loaded and centered (such as by vacuum inducing forces not shown) onto a vacuum worktable associated with the numerically guided colorization assembly.

At step 54, a numerically driven ink applying head (see at 42 in FIG. 3) is traversed along the XY coordinate system to paint a desired representation selected from a file associated with a software based program in operative communication with the ink head CNC controller, see further at 56. As previously described, step 58 corresponds to a two coat colorization process and by which a first neutral white coat is followed by a succeeding multicolorization coat applied in a seamless and continuous linear and iteratively fed fashion.

At step 60, the article (such as a solid, plaque or other suitable workpiece) is removed from the machining center, following which (at step 62) the inked surface is dried or polished. Finally, at 64, an environmentally sealing and UV protecting coating (including clear and partially transparent coatings) is applied to the finished article.

A numerically controllable and colorant applying assembly for colorizing the article surface is also disclosed according to the process previously described. An associated software program cooperatively employed with the assembly numerical processor includes subroutines for projecting an XY grid representation of the colorized scheme to be applied to the article surface, and applying the colorant scheme, such as again in a two coat and continuous linear feed fashion.

In additional variants, the multicolorant fluid applicator is capable of being traversable in an XYZ guided manner relative to a three-dimensional surface of an associated 3D article. An associated numerical controller guides the relative motion between the fluid colorant applicator and the three-dimensional surface of the article.

A software program is in operative communication with a processor output of the controller and contains a file associated with a colorant scheme to be applied onto the three-dimensional surface of the article by the fluid colorant applicator. A predetermined image may be generated in three dimensions using an optical scanner.

Additional considerations applied to an XYZ NC controllable embodiment include the article being attached to a fixed worktable, and the fluid colorant applicator being traversable in XYZ guided manner relative to the worktable. Alternatively, the fixed fluid colorant applicator and article are attached to a worktable traversable in XYZ guided manner relative to the fluid colorant applicator.

The numerical controller is slaved to a 3D polymer deposition machine, and in order to create a three-dimensional article by “building up” layers of material onto the article to in turn build up the three-dimensional surface. The numerical controller and associated machining device may otherwise be reconfigured to remove layers from a desired three-dimensional article, and in order to form a reduced three-dimensional surface.

In application, the numerical controller may drive a CNC routing system to remove material from the article to produce the desired three-dimensional surface. The article produced may be configured or constructed from any of a variety of materials, including those chosen from the group including steel, bronze, aluminum, wood, polymer, silver, nickel, stainless steel, and titanium. Alternatively, the article is made from a material chosen from a group including solid metallic materials and solid non-metallic materials.

Accordingly, the present invention discloses a novel surface colorization method, assembly, article and associated computer writeable medium capable of digitally/numerically painting a desired representation upon an article surface. The present invention contemplates painting and sealing a wide variety of articles, including memorials, three-dimensional shaped articles, including both memorials and other unrelated signage, as well as any type of solid metallic or non-metallic substrate material.

Having described my invention, other and additional preferred embodiments will become apparent to those skilled in the art to which it pertains, and without deviating from the scope of the appended claims.

1. A method for surface applying a color scheme, comprising the steps of:
providing an article having a specified shape and size;
texturing a surface of the article;
securing said article upon a worktable associated with a numerically controllable colorant applicator;
applying said colorant upon said textured surface; and
applying a sealant over said colored and textured surface.

2. The method as described in claim 1, said step of texturing further comprising sandblasting said article surface with a plurality of glass beads.

3. The method as described in claim 1, further comprising the step of forming recessed surfaces on a non-colored surface of said article.

4. The method as described in claim 1, further comprising the step of securing fastener receiving mounting studs to a non-colored surface of said article.

5. The method as described in claim 4, said step of securing studs further comprising welding incorporating a capacitor discharge arcing process.

6. The method as described in claim 1, said step of applying said colorant further comprising a first white background coating applied upon said textured surface, followed by at least one additional color applied in a second overlaying coating.

7. The method as described in claim 6, said step of applying said colorant further comprising the step of numerically guiding a multicolor ink applying head upon a three-dimensional XYZ coordinate grid projected upon said textured surface.

8. The method as described in claim 7, further comprising the step of applying a plurality of colors during a continuous and straight line translation of said article relative to said ink applying head.

9. The method as described in claim 6, said step of applying said colorant further comprising translating said article-supporting worktable in XYZ coordinate fashion relative to a fixed colorant applicator.

10. The method as described in claim 1, further comprising the step of drying said colorant upon said textured surface and prior to application of said sealant.

11. The method as described in claim 10, further comprising the step of polishing at least a part of said textured surface prior to said sealant.

12. The method as described in claim 1, said step of applying said sealant further comprising applying a clear acrylic exhibiting an ultraviolet inhibitor.

13. The method as described in claim 1, said step of applying said sealant further comprising at least one of spraying, brushing, rolling, and powder coating a transparent and moisture/ultraviolet-resistant material including at least a thermosetting acrylic urethane.

14. The method as described in claim 1, said step of securing said article further comprising vacuum drawing said article against said worktable.

15. The method as described in claim 3, further comprising the step of locating said article upon said worktable according to locations of said recessed surfaces.

16. The method as described in claim 1, said article further comprising a metallic solid, further comprising the step of engraving said solid prior to applying said sealant.

17. A numerically controllable colorant applying assembly for colorizing an article with a three-dimensional surface corresponding to a predetermined image comprising:
a multicolorant fluid applicator traversable in an XYZ guided manner relative to said three-dimensional surface of said article; and
a numerical controller for guiding relative motion between said fluid colorant applicator and said three-dimensional surface of said article, and a software program in operative communication with a processor output of said controller and containing a file associated with a colorant scheme to be applied onto the three-dimensional surface of said article by the fluid colorant applicator.

18. The assembly as described in claim 17, further comprising a vacuum drawing the article against said worktable surface.

19. The assembly as described in claim 17, further comprising applying a first white background coating applied upon the article surface, followed by at least one additional color applied in a second overlaying coating.

20. The assembly as described in claim 19, further comprising applying a plurality of colors during a continuous and straight line translation of the article relative to the fluid colorant applicator.

21. The assembly as described in claim 17, said fluid colorant applicator applying at least one of an ink and a dye.

22. The assembly as described in claim 17, further comprising said worktable traversing upon an XYZ slide assembly relative to a fixedly positioned fluid colorant applicator.

23. An article exhibiting a surface applied color scheme, according to the following steps:
texturing a surface of the article;
applying a colorant upon said textured surface in a numerically controllable fashion; and
applying a sealant over said colorant applied and textured surface.

24. The article as described in claim 23, said article exhibiting a specified shape and size and further comprising a metallic based solid including at least one of a steel, bronze, silver, nickel, stainless steel or titanium material.

25. The article as described in claim 23, said article exhibiting a specified shape and size and further comprising a cellulose based material.

26. The article as described in claim 24, further comprising an engraving formed in the article surface prior to application of said sealant.

27. The article as described in claim 23, said sealant further comprising a substantially transparent and environmentally resistant material.

28. The article as described in claim 27, said sealant further comprising a clear acrylic exhibiting an ultraviolet inhibitor.

29. The article as described in claim 23, further comprising the step of establishing centering locations upon a reverse surface of a three-dimensional article.

30. The article as described in claim 29, further comprising the step of securing fastener receiving mounting studs to the reverse surface of the article according to a capacitor discharge arc welding process.

31. The article as described in claim 23, said article exhibiting a specified shape and size and further comprising at least a memorial plaque.

32. A computer writeable medium for surface applying a fluid based colorant scheme upon an article, comprising:
a first subroutine for projecting a multidimensional and multicolored representation upon a surface of said article; and
a second subroutine for traversing a numerically controllable and multicolorant applying assembly according to said projected representation.

33. The computer writeable medium as described in claim 32, further comprising an additional subroutine for applying a first white background coating applied upon said textured surface, followed by at least one additional color applied in a second overlaying coating.

34. The computer writeable medium as described in claim 32, further comprising an additional subroutine for applying a plurality of colors during a continuous and straight line translation of said article relative to said ink applying head.

35. The computer writeable medium as described in claim 32, further comprising the step of projecting said representation and applying said colorant in an XYZ coordinating fashion.

36. The assembly as described in claim 17, further comprising said article being attached to a fixed worktable and said fluid colorant applicator being traversable in XYZ guided manner relative to said worktable.

37. The assembly as described in claim 17, further comprising a fixed fluid colorant applicator and said article being attached to a worktable traversable in XYZ guided manner relative to said fluid colorant applicator.

38. The assembly as described in claim 17, including a numerical controller for creating said three-dimensional surface on said article.

39. The assembly of claim 38 in which a numerical controller drives the application of layers of material onto said article to build up said three-dimensional surface.

40. The assembly of claim 38 in which a numerical controller drives the removal of layers from said article to form said three-dimensional surface.

41. The assembly of claim 38 in which a numerical controller drives a CNC routing system to remove material from said article to produce said three-dimensional surface.

42. The assembly of claim 17 wherein said article is made from a material chosen from the group consisting of steel, bronze, aluminum, wood, polymer, silver, nickel, stainless steel, and titanium.

43. The assembly of claim 17 wherein said article is made from a material chosen from the group consisting of solid metallic materials and solid non-metallic materials.

44. The assembly of claim 17 wherein said predetermined image is generated in three dimensions using an optical scanner.
